(19) United States
(12) Patent Application Publication
(10) Pub. No.: US 2024/0192496 A1
(43) Pub. Date: Jun. 13, 2024

(54) VIRTUAL IMAGE DISPLAY DEVICE AND HEAD-MOUNTED DISPLAY APPARATUS

(71) Applicant: SEIKO EPSON CORPORATION, Tokyo (JP)

(72) Inventor: Mitsutaka IDE, SHIOJIRI-SHI, NAGANO-KEN (JP)

(73) Assignee: SEIKO EPSON CORPORATION, Tokyo (JP)

(21) Appl. No.: 18/528,807

(22) Filed: Dec. 5, 2023

(30) Foreign Application Priority Data
Dec. 8, 2022 (JP) 2022-196176

(51) Int. Cl. G02B 27/01; G02B 5/00; G02B 27/09

(52) U.S. Cl. CPC G02B 27/0172; G02B 5/003; G02B 27/0961; G02B 2027/0192

(57) ABSTRACT

A virtual image display device includes an image display device including a pixel display region for displaying an image and a light transmitting region for causing external scenes to be visually recognizable, an optical array being arranged on a face side of the image display device, including a plurality of micro optical elements provided corresponding to respective pixels, and being configured to form an image with image light emitted from the image display device, and a light shielding member being arranged on an external side of the image display device and being configured to suppress incidence of external light on the pixel display region.

The present application is based on, and claims priority from JP Application Serial Number 2022-196176, filed Dec. 8, 2022, the disclosure of which is hereby incorporated by reference herein in its entirety.

### BACKGROUND

### 1. Technical Field

The present disclosure relates to a virtual image display device and a head-mounted display apparatus that enable observation of a virtual image, and more particularly to a virtual image display device and the like of a see-through type that enable visual recognition of an external image.

### 2. Related Art

As a virtual image display device of a see-through type that enables visual recognition of external scenes, there has been publicly known a virtual image display device including a liquid crystal panel that includes an image display region and a transparent display region formed to surround the image display region, and a light guiding plate that guides backlight light entering an end portion from a light source, wherein the light guiding plate includes a light emitting region in which the image display region of the liquid crystal panel is irradiated with the backlight light and a light transmitting region that transmits environmental light (International Publication No. WO 2016/056298). The display device is configured so that the environmental light reaches an observer through the light transmitting region of the light guiding plate and the transparent display region of the liquid crystal panel while the environmental light, which is transmitted through the light emitting region of the light guiding plate and the image display region of the liquid crystal panel, reaches the observer for a period during which the image display region is not irradiated with the backlight light. With this configuration, see-through display obtained by overlapping image light and environmental light with each other is achieved.

In the device described above, the light emitting region of the light guiding plate is subjected to treatment such as formation of dots and application of a scattering agent, and the environmental light passing through the image display region of the liquid crystal panel also passes through the light emitting region subjected to the treatment. As a result, near a center of a visual field corresponding to the image display region, a see-through transmittance is reduced. In order to achieve see-through display with a high see-through transmittance near the center of the visual field, an optical system with a high see-through transmittance or the like is additionally required, which leads to the size increase.

### SUMMARY

According to one aspect of the present disclosure, a virtual image display device includes an image display device including a pixel display region for displaying an image and a light transmitting region for causing external scenes to be visually recognizable, an optical array being arranged on a face side of the image display device, including a plurality of micro optical elements provided corresponding to respective pixels, and being configured to form an image with image light emitted from the image display device, and a light shielding member being arranged on an external side of the image display device and being configured to suppress incidence of external light on the pixel display region.

### BRIEF DESCRIPTION OF THE DRAWINGS

FIG. 1 is an external perspective view for describing a mounted state of a virtual image display device according of a first exemplary embodiment.

FIG. 2 is a schematic perspective view for describing an optical structure of a display optical system.

FIG. 3 is an enlarged perspective view for describing a repetition unit of a composite display member.

FIG. 4A is a schematic perspective view for describing one example of a specific configuration of a light emitting element.

FIG. 4B is a schematic perspective view for describing another example of the light emitting element.

FIG. 5 is a plan view for describing arrangement of pixels in association with FIG. 4A.

FIG. 6 is a schematic view for describing an operation of the virtual image display device of the first exemplary embodiment.

FIG. 7 is a schematic view for describing a virtual image display device of a second exemplary embodiment.

FIG. 8 is a schematic view for describing a virtual image display device of a third exemplary embodiment.

FIG. 9 is a view for describing an example of a pupil expanding element.

FIG. 10 is a view for describing another example of the pupil expanding element.

FIG. 11 is a view for describing a modification example of a display optical system.

### DESCRIPTION OF EMBODIMENTS

### First Exemplary Embodiment

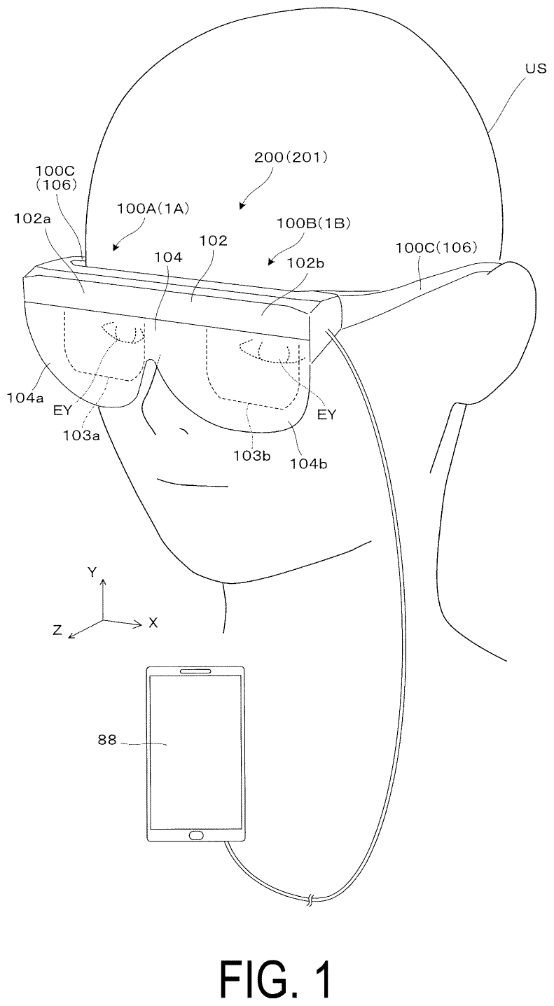

With reference to FIGS. 1 to 6, a virtual image display device and the like according to a first exemplary embodiment of the present disclosure are described below.

FIG. 1 is a perspective view for describing a mounted state of a head-mounted display, in other words, a head-mounted display apparatus 200. The head-mounted display apparatus (hereinafter, also referred to as an HMD) 200 is a display apparatus 201 of a binocular type, and allows an observer or a wearer US who wears the HMD 200 to recognize a video as a virtual image. In FIG. 1 and the like, X, Y, and Z indicate an orthogonal coordinate system, a +X direction corresponds to a lateral direction in which both eyes EY of the observer or wearer US wearing the HMD 200 are aligned, a +Y direction corresponds to an upward direction orthogonal to the lateral direction in which both the eyes EY are aligned for the wearer US, and a +Z direction corresponds to a forward or front direction for the wearer US. The ±Y directions are parallel to the vertical axis or the vertical direction.

The HMD 200 includes a first virtual image display device 100A for a right eye, a second virtual image display device 100B for a left eye, a pair of temples 100C that support the virtual image display devices 100A and 100B, and a user terminal 88 being an information terminal. The first virtual image display device 100A is a first device 1A, and is constituted by a first display driving unit 102a that is arranged in an upper part, a first display optical system 103a that covers the front of the eyes, and a light transmitting cover 104a that covers the first display optical system 103a from the external side or the front side thereof. The second virtual image display device 100B is a second device 1B, and is constituted by a second display driving unit 102b that is arranged in an upper part, a second display optical system 103b that covers the front of the eyes, and a light transmitting cover 104b that covers the second display optical system 103b from the external side or the front side thereof. The HMD 200 obtained by combining the first virtual image display device 100A being the first device 1A and the second virtual image display device 100B being the second device 1B with each other is also a virtual image display device in a broader sense. The pair of temples 100C function as a mounting member or a support device 106 that is worn on the head of the wearer US, and support the upper end sides of the pair of display optical systems 103a and 103b and the upper end sides of the pair of light transmitting covers 104a and 104b via the display driving units 102a and 102b integrated in exterior. A combination of the pair of display driving units 102a and 102b is referred to as a driving device 102. A combination of the pair of light transmitting covers 104a and 104b is referred to as a shade 104.

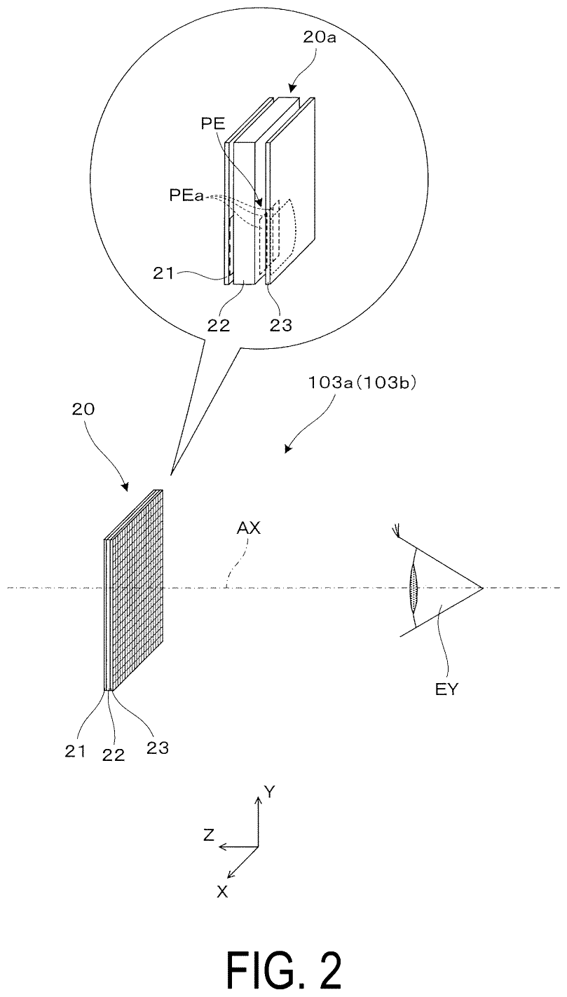

FIG. 2 is a perspective view for describing a structure of the first display optical system 103a. The first display optical system 103a includes a plate-like composite display member 20 that forms a two-dimensional image and emits image light. The composite display member 20 is a plate-like member that extends parallel to an XY plane vertical to the optical axis AX, and has a structure in which a light shielding member 21, an image display device 22, and an optical array 23 are laminated and integrated with each other by a frame body, which is omitted in illustration. The composite display member 20 is configured by a plurality of repetition units 20a that are arrayed in a matrix along the XY plane. The repetition unit 20a includes pixels PE each of which is a unit for forming an image in the image display device 22. Each of the pixels PE is configured by three sub pixels PEa. The light shielding member 21, the image display device 22, and the optical array 23 are coupled and fixed at a predetermined interval. With this, the device can be relatively reduced in thickness. Note that the light shielding member 21, the image display device 22, and the optical array 23 may be close to each other. In the first display optical system 103a, a distance between the eye EY and the optical array 23 is approximately 15 mm, for example.

The second display optical system 103b is optically similar to the first display optical system 103a, or is obtained by inverting the first display optical system 103a horizontally. Thus, detail description thereof is omitted.

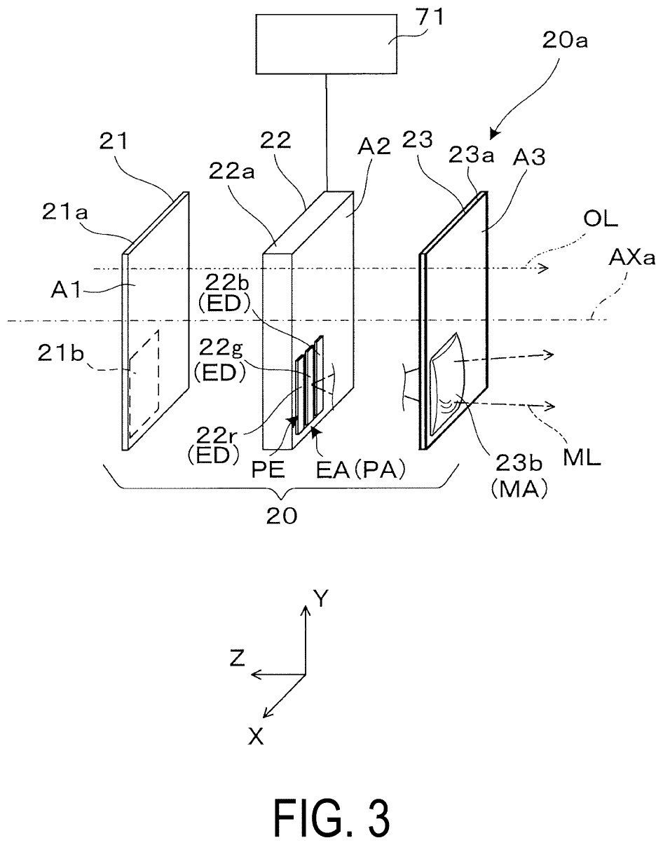

FIG. 3 is an enlarged perspective view for describing the repetition unit 20a of the composite display member 20. Here, an axis AXa is an axis parallel to the optical axis AX illustrated in FIG. 1.

The light shielding member 21 is obtained by providing a rectangular light shielding layer 21b on a flat plate 21a having light transmittance. In FIG. 3, the light shielding layer 21b is provided to the flat plate 21a on the external side, but may be provided thereto on the side close to the image display device 22. Although omitted in illustration, on the entire light shielding member 21, the large number of light shielding layers 21b are arrayed in a matrix along the XY plane. In other words, all the light shielding layers 21b constituting the light shielding member 21 are two-dimensionally arrayed periodically with respect to the horizontal X direction and the vertical Y direction. Each of the light shielding members 21b is formed in a region corresponding to a pixel section in each of the repetition units 20a. A light transmitting region A1 of the light shielding member 21 in which the light shielding layer 21b is not provided transmits external light OL, and the light shielding layer 21b suppresses passage of the external light OL.

The light shielding layer 21b is formed by light-absorbing paint or other substances that can be applied to a desired area by an ink-jet method, for example. A mold release pattern formed of a mold release agent is recorded in advance at a position on the flat plate 21a at which the light shielding layer 21b is not formed. A spray containing light-absorbing substances is applied over the entire surface, and then the light-absorbing substances are removed at the position corresponding to the mold release pattern. With this, the light shielding layer 21b may be formed of the remaining light-absorbing substance layer. Paint having a color other than black may be used for the light shielding layer 21b as long as substances contained therein has a light-absorbing action. Moreover, a metal pattern is formed by using a photo-resist technique or the like at a position on the flat plate 21a at which the light shielding layer 21b is to be formed, and the metal pattern is oxidized to improve an absorbing property. The light shielding layer 21b may be thus formed.

The image display device 22 is arranged on the face side of the light shielding member 21. The image display device 22 is a transparent display of a self light emitting type, for example, an organic EL display. The image display device 22 is obtained by providing light emitting layers 22r, 22g, and 22b being light emitting regions EA on a flat plate 22a having light transmittance. The light emitting region EA is also referred to as a pixel display region PA, and the light emitting layers 22r, 22g, and 22b are also referred to as light emitting elements ED. A driving circuit 71 causes the light emitting layers 22r, 22g, and 22b to emit image light ML at timing and a luminance degree required for display. Specifically, the light emitting layer 22r for a red color emits red image light at timing and a luminance degree required for display, the light emitting layer 22g for a green color emits green image light at timing and a luminance degree required for display, and the light emitting layer 22b for a blue color emits blue image light at timing and a luminance degree required for display. Although omitted in illustration, on the entire image display device 22, the large number of pixels PE in which the three light emitting layers 22r, 22g, and 22b form a group are arrayed in a matrix along the XY plane. In other words, all the pixels PE or all the groups of the light emitting layers 22r, 22g, and 22b that constitute the image display device 22 are two-dimensionally arrayed periodically with respect to the horizontal X direction and the vertical Y direction. Each of the pixels PE, in other words, one group of the light emitting layers 22r, 22g, and 22b are formed in a region corresponding to a pixel section in each of the repetition units 20a. In the image display device 22, a light transmitting region A2 in which the light emitting layers 22r, 22g, and 22b are not provided transmit the external light OL. The light emitting layers 22r, 22g, and 22b block the external light OL at least at timing of lighting.

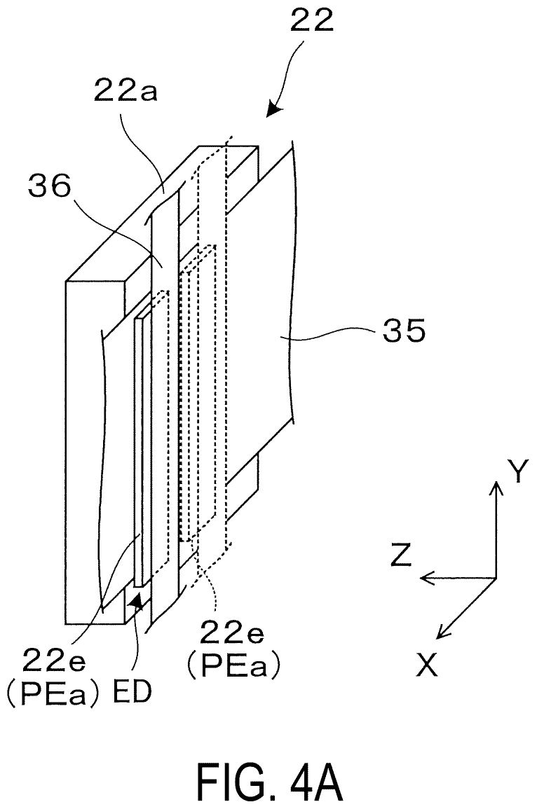

FIG. 4A is a schematic perspective view for describing one example of a specific structure of the light emitting element ED. For convenience of description, FIG. 4A illustrates one light emitting element ED. The light emitting element ED illustrated herein is a display cell of a passive matrix type. The flat plate 22a being a base plate for supporting the light emitting element ED is formed of glass or plastic having light transmittance. On the flat plate 22a, a first electrode wiring line 35 that extends in the horizontal X direction and has light transmittance is formed. The light emitting layer 22e corresponding to the sub pixel PEa is formed at a display position on the first electrode wiring line 35. The light emitting layer 22e is any one of the light emitting layers 22r, 22g, and 22b that are illustrated in FIG. 3. The light emitting element ED is an organic EL light emitting element, for example. In this case, the light emitting layer 22e is an organic substance layer containing fluorescent substances or the like, and contain an injection layer for an electron or a hole (not illustrated) or the like as required. A second electrode wiring line 36 that extends the vertical Y direction and has light transmittance is formed to cover the light emitting layer 22e. The first and second electrode wiring lines 35 and 36 use transparent electrodes such as ITO. The light emitting layer 22e can selectively be caused to emit light by supplying power required for the first electrode wiring line 35 and the second electrode wiring line 36 from the outside.

FIG. 4B is a schematic perspective view for describing another example of the light emitting element ED. For convenience of description, FIG. 4B illustrates one light emitting element ED. The light emitting element ED illustrated herein is a display cell of an active matrix type. The flat plate 22a being a base plate for supporting the light emitting element ED is formed of glass or plastic having light transmittance. On the flat plate 22a, a first transparent electrode 31 being a common electrode is uniformly formed. A light emitting layer 22e corresponding to the sub pixel PEa and the driving element 22d being a switch element are formed at a display position on the first transparent electrode 31. A combination of the light emitting layer 22e and the driving element 22d on an upper right side thereof is referred to as the light emitting element ED. The light emitting layer 22e is any one of the light emitting layers 22r, 22g, and 22b that are illustrated in FIG. 3. The light emitting element ED is an organic EL light emitting element, for example. An output of the driving element 22d is supplied to a second transparent electrode 32 that is provided to cover the light emitting layer 22e. A power supply wiring line 33 that extends in the vertical Y direction and has light transmittance and a switch wiring line 34 that extends in the horizontal X direction and has light transmittance are connected to a terminal of the driving element 22d (not illustrated). The light emitting layer 22e can selectively be caused to emit light by supplying a driving signal from the outside to the switch wiring line 34. The driving element 22d blocks the external light OL, and the light emitting layer 22e blocks the external light OL at least at timing of lighting.

As described above, the image display device 22 may include a self light emitting element of a passive matrix type, or may include a self light emitting element of an active matrix type. Further, the image display device 22 may be liquid crystal or a micro LED that have light transmittance. In a case of the self light emitting element of an active matrix type, a transistor in each of the sub pixels PEa may have malfunction due to light, or flickering may occur due to a metal film for the transistor. In such cases, the light shielding member 21 is used to suppress incidence of the external light OL on the light emitting element ED.

The optical array 23 is arranged on the face side of the image display device 22. The optical array 23 is obtained by providing a square or rectangular micro optical element 23b in plan view on a flat plate 23a having light transmittance. Although omitted in illustration, on the entire optical array 23, the large number of micro optical elements 23b are arrayed in a matrix along the XY plane. In other words, all the micro optical elements 23b constituting the optical array 23 are two-dimensionally arrayed periodically with respect to the horizontal X direction and the vertical Y direction. Each of the micro optical elements 23b is formed in a region corresponding to a pixel section in each of the repetition units 20a. One micro optical element 23b is arranged with respect to one pixel PE, specifically, one light emitting region EA, for example. In a light transmitting region A3 of the optical array 23 in which the micro optical element 23b is not provided, the external light OL is transmitted therethrough and is not subjected to an action of the optical element. In contrast, in the micro optical element 23b, the light shielding member 21 suppresses incidence of the external light OL, and the light emitted from the light emitting region EA is transmitted and subjected to an action of the optical element.

As described above, the optical array 23 includes the plurality of micro optical elements 23b that cause the light emitted from each of the pixels PE or the sub pixels PEa constituting the image display device 22 to form an image individually. The plurality of micro optical elements 23b are arranged in the vicinity of the image display device 22, and hence the virtual image display device 100A can be reduced in thickness.

For example, the micro optical element 23b is a micro lens MA. In this case, the entire optical array 23 is a micro lens array. For example, the micro lens MA is a flat convex lens having a rectangular shape in a plan view. The micro lens MA refracts the image light ML individually in each of the repetition units 20a. When the micro optical element 23b causes the light emitted from the pixels PE to form an image, the image is formed with the colored image light ML emitted from the plurality of light emitting layers 22e corresponding to the pixels PE. When the micro optical element 23b causes the light emitted from the sub pixels PEa to form an image, the image is formed with the single-colored image light ML emitted from the light emitting layers 22e corresponding to the sub pixels PEa.

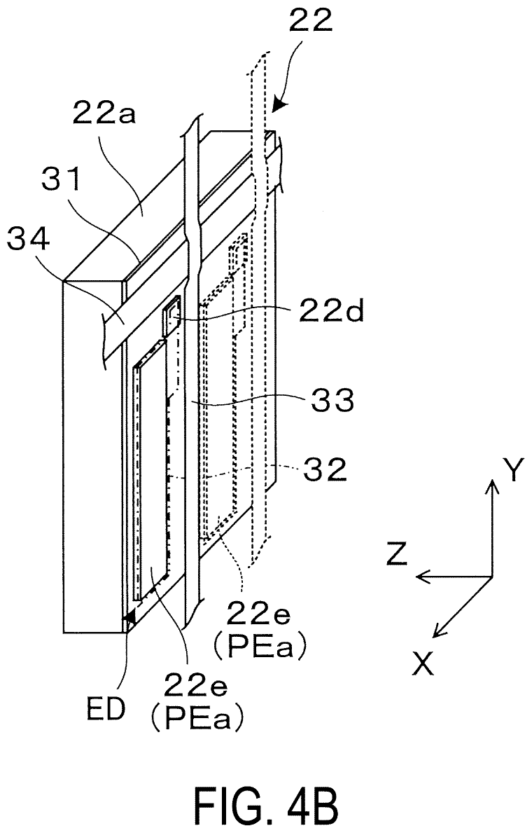

FIG. 5 is a schematic view for describing arrangement of the pixels PE on the image display device 22. The image display device 22 is obtained by arraying repetition sections 22s each having a rectangular outline, in the X direction and the Y direction. Each of the repetition sections 22s includes a pixel section 22t on the lower left side, and the light transmitting region A2 is formed within a range of the repetition sections 22s other than the pixel section 22t. The pixel section 22t is a pixel display region PA for displaying an image. The pixel section 22t includes the light emitting element ED having the structure illustrated in FIG. 4A. In the pixel section 22t as a whole, the light emitting layers 22r, 22g, and 22b are included.

Note that arrangement and other details of the pixels in the case of the light emitting element ED illustrated in FIG. 4B are similar to those in the case of the light emitting element ED illustrated in FIG. 4A. However, the light transmitting region A2 in the periphery of the light emitting layers 22r, 22g, and 22b is a circuit region in which the power supply wiring line 33, the switch wiring line 34, and the like, which are illustrated in FIG. 4B, are provided.

On the image display device 22 illustrated in FIG. 5, the light shielding layer 21b of the light shielding member 21 illustrated in FIG. 3 and the micro optical element 23b of the optical array 23 are illustrated while overlapping with each other. For convenience of description, FIG. 5 illustrates the light shielding layer 21b, the pixel section 22t, and the micro optical element 23b while slightly changing the sizes thereof.

The light shielding layer 21b of the light shielding member 21 has a size corresponding to the pixel display region PA. With this, incidence of the external light OL on the pixel display region PA can further be suppressed. The light shielding layer 21b covers the pixel section 22t and is formed in a region that spreads slightly outward from the pixel section 22t, but may be formed in a region matching with the pixel section 22t.

The micro optical element 23b has a size corresponding to the pixel display region PA. With this, the light shielding layer 21b of the light shielding member 21 can be limited to a minimal necessary area, and hence the transmittance of the external light OL can be increased. The micro optical element 23b has a size corresponding to the light shielding layer 21b of the light shielding member 21. With this, incidence of the external light OL on the micro optical element 23b, which is blocked by the light shielding layer 21b, can be prevented. The micro optical element 23b has a shape corresponding to the pixel display region PA. With this, the light shielding layer 21b of the light shielding member 21 can be limited to a minimal necessary area, and hence the transmittance of the external light OL can be increased. The micro optical element 23b covers the pixel section 22t and is formed in a region that spreads slightly outward from the pixel section 22t, but may be formed in a region matching with the pixel section 22t.

The light shielding layer 21b of the light shielding member 21 is arranged in a region corresponding to the pixel PE or the sub pixel PEa of the pixel display region PA. The transmittance of the external light OL can be increased while the light shielding layer 21b provided to each of the pixels PE prevents the external light OL from entering a path of the image light ML and being stray light. The micro optical element 23b is arranged in a region corresponding to the pixel display region PA or the light emitting region EA. With this, the image light ML that is emitted from the light emitting region EA to the face side can be used for formation of a virtual image while suppressing incidence of the external light OL on the micro optical element 23b.

Specifically, when the light shielding layer 21b of the light shielding member 21 is arranged in a region corresponding to the pixel PE of the pixel display region PA, the micro optical element 23b is arranged in a region corresponding to the pixel PE. In this case, the light shielding layer 21b suppresses incidence of the external light OL on the pixel PE, and the micro optical element 23b forms an image with the image light ML of each of the pixels PE. Further, when the light shielding layer 21b is arranged in a region corresponding to the sub pixel PEa, the micro optical element 23b is arranged in a region corresponding to the sub pixel PEa. In this case, the light shielding layer 21b suppresses incidence of the external light OL on the sub pixel Pea, and the micro optical element 23b forms an image with the image light ML of each of the sub pixels PEa.

Note that, when an angle of view is increased in the first display optical system 103a, the micro optical element 23b may have such a shape that the light is bent more inward as the micro optical element 23b is arranged closer to the outer circumferential side of the optical array 23. For example, inclination of the entire optical surface of the micro optical element 23b is changed according to the distance from the optical axis AX. Further, the micro optical element 23b that is arranged on the outer circumferential side of the optical array 23 may be shifted from the axis AXa of the pixel display region PA or the light emitting region EA without incidence of the external light OL.

With reference to FIG. 5, the repetition section 22s may be regarded as a combination of an external light visual recognition pixel X1 being the light transmitting region A2 and an image light emission pixel X2 being the pixel section 22t or the pixel display region PA, and is also referred to as a see-through image display pixel TX. The see-through image display pixel TX locally blocks the external light OL, and forms a pixel at a shielded position. In view of this, the see-through image display pixel TX may be regarded as a pixel that allows a background scene to be viewed in a see-through manner. The external light OL that is not blocked by the light shielding member 21 passes through the light transmitting region A2 being a part of the see-through image display pixel TX of the image display device 22, and passes through the light transmitting region A3 of the optical array 23. Meanwhile, the image light ML that is emitted from the pixel display region PA being a part of the see-through image display pixel TX passes through the micro optical element 23b of the optical array 23 while being subjected to a light condensing action or a lens action, and is converted into a virtual image of the pixel display region PA.

The image display device 22 has a size of 2 inches, and has an angle of view of approximately 130 degrees, for example. The pixel PE has a size having one side approximately from 10 μm to 50 μm. Note that, when only text information is involved in an optical system close to collimation, the pixel PE may be a size of approximately 100 μm. A ratio of an area of the light transmitting region A2 to the repetition section 22s, that is, a see-through aperture ratio is approximately from 5% to 10%, for example. With a see-through aperture ratio of approximately 5%, a resolution of approximately 2K can be achieved.

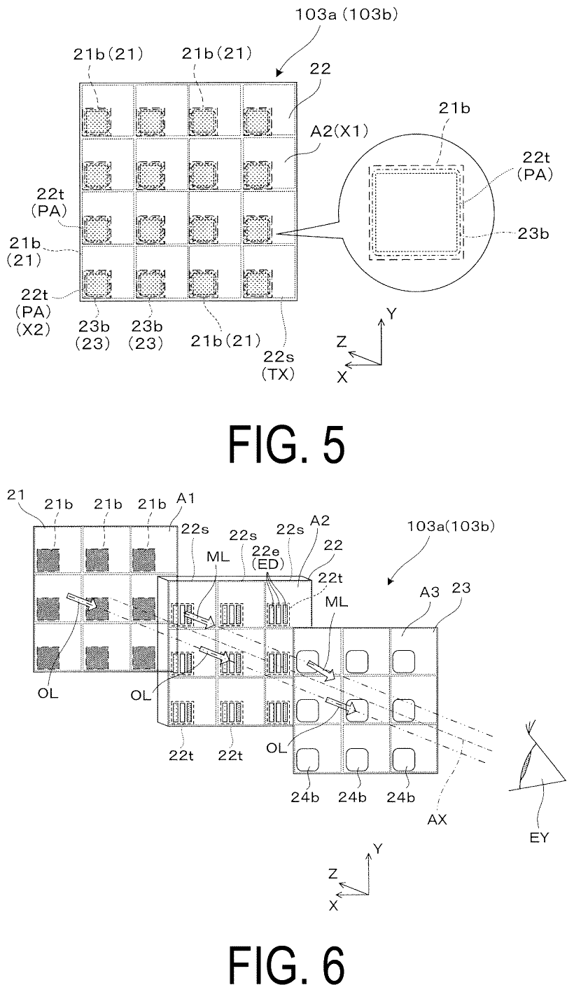

With reference to FIG. 6, the image light ML emitted from the light emitting element ED or the light emitting layer 22e of the image display device 22 forms a virtual image via the micro optical element 23b of the optical array 23. Here, the light shielding layer 21b of the light shielding member 21 separates the image light ML from the external light OL and the image light ML that are emitted from the repetition section 22s obtained by combining an external light visual recognition pixel X1 and an image light emission pixel X2 with each other. With this, a virtual image is formed. An image that is formed on by the pixels PE or the sub pixels PEa of the image display device 22 being a transparent display is observed by the eyes EY of the wearer as a virtual at a desired magnification ratio behind the image display device 22. Meanwhile, the external light OL passes through the light transmitting region A1 of the light shielding member 21, passes through the light transmitting region A2 being a part of the see-through image display pixel TX of the image display device 22, and passes through the light transmitting region A3 of the optical array 23. In this state, the external light OL is not subjected to an optical action or a lens action by the light shielding member 21, the image display device 22, and the optical array 23. A general external image is observed by the eyes EY of the wearer. In other words, an external image can be recognized in a see-through view via the display optical systems 103a and 103b.

The virtual image display devices 100A and 100B of the first exemplary embodiment described above each includes the image display device 22 that includes the pixel display region PA for displaying an image and the light transmitting region A2 for causing external scenes to be visually recognizable, the optical array 23 that is arranged on the face side of the image display device 22, includes the plurality of micro optical elements 23b provided corresponding to the respective pixels PE, and forms an image with the image light ML emitted from the image display device 22, and the light shielding member 21 that is arranged on the external side of the image display device 22 and suppresses incidence of the external light OL on the pixel display region PA.

In the virtual image display devices 100A and 100B described above, the transmitted light that passes through the light shielding member 21 from the external side passes through without being subjected to an action of the optical element, and the image light ML that is emitted from the pixel display region PA of the image display device 22 passes through while being subjected to an action of the optical element, and forms a virtual image. In other words, the virtual image display devices 100A and 100B separate the image light ML and the external light OL from each other, and cause the image light ML and the external light OL to coexist. The image display device 22 includes the light transmitting region A2 to achieve a see-through state. Thus, an additional relay optical system or the like is not required, and the device can be reduced in size. Further, the light shielding member 21 suppresses incidence of the external light OL on the pixel display region PA. With this, incidence of the external light OL on the optical array 23 via the pixel display region PA can be suppressed. With this, the external light OL is not subjected to an action of the optical element. Thus, the external light OL can be prevented from being visually recognized as a multiple image, and see-through performance can be improved. The light shielding member 21 and the optical array 23 are combined with the image display device 22, as described above. With this, the device can be reduced in size, and an angle of field can be increased.

### Second Exemplary Embodiment

A virtual image display device according to a second exemplary embodiment is described below. The virtual image display device according to the second exemplary embodiment is obtained by partially modifying the virtual image display device according to the first exemplary embodiment, and description of parts in common with those of the virtual image display device according to the first exemplary embodiment is omitted.

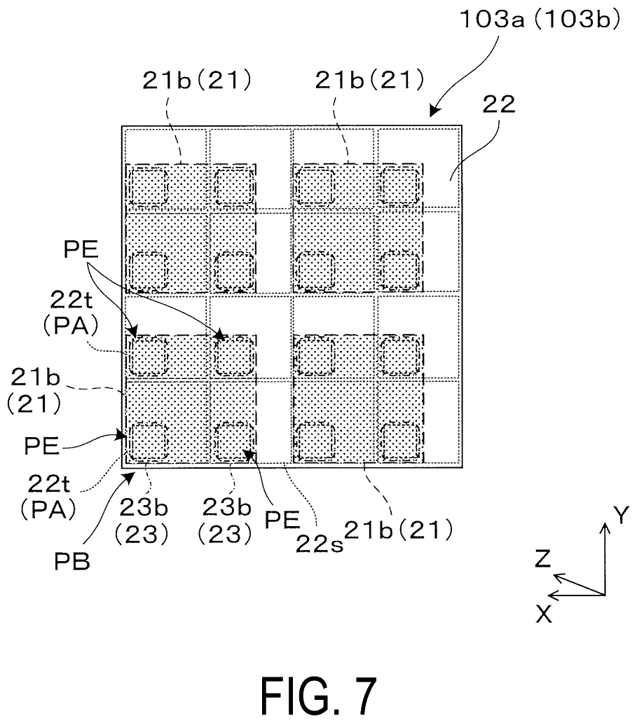

With reference to FIG. 7, in the virtual image display devices 100A and 100B or the HMD 200 of the second exemplary embodiment, the light shielding layer 21b of the light shielding member 21 is arranged over the plurality of pixels PE. A group of the plurality of pixels PE is referred to as a composite pixel PB. For example, the composite pixel PB is a group of the pixels PE in a form of 2×2, 3×3, or the like. In the illustrated example, the light shielding layer 21b is arranged to cover the four pixels PE, in other words, the composite pixel PB. As the resolution is increased, it is more difficult to arrange the light shielding layer 21b with each of the pixels PE on a one-to-one basis. In such a case, the virtual image display device 100A and the like of the present exemplary embodiment are effective. In this case, in the image display device 22, the region through which the external light OL is transmitted is reduced, but see-through performance of the image display device 22 as a whole can be secured.

In the second exemplary embodiment, not only the light shielding layer 21b of the light shielding member 21 but also the micro optical element 23b of the optical array 23 may be arranged in association with the light shielding layer 21b over the plurality of pixels PE.

### Third Exemplary Embodiment

A virtual image display device according to a third exemplary embodiment is described below. The virtual image display device according to the third exemplary embodiment is obtained by partially modifying the virtual image display device according to the first exemplary embodiment, and description of parts in common with those of the virtual image display device according to the first exemplary embodiment is omitted.

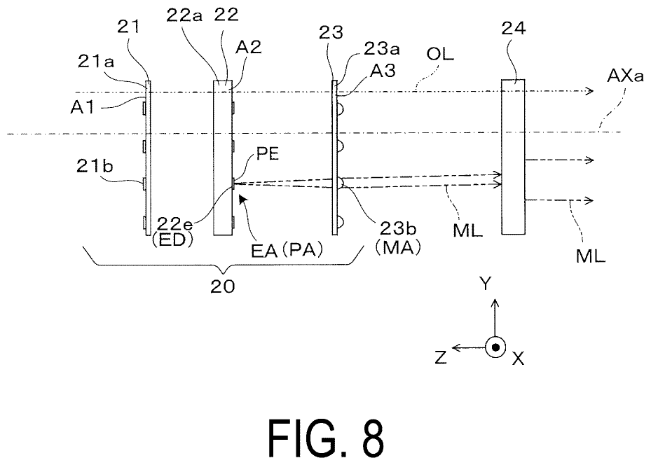

With reference to FIG. 8, in the virtual image display devices 100A and 100B or the HMD 200 of the third exemplary embodiment, a pupil expanding element 24 is arranged on the face side of the optical array 23. In a case in which the optical array 23 includes the micro optical element 23b such as the micro lens MA, when the micro optical element 23b is separated away from the light emitting source, an eye box is relatively reduced. By providing the pupil expanding element 24, a degree of freedom in arrangement of the optical system with respect to the eye EY of the wearer can be increased, and an image can be viewed comfortably while the eye EY moves. Note that, when the optical array 23 is separated away from the image display device 22, the lens shape of the micro lens MA is preferably adjusted in order to widen an angle of view. Examples of the pupil expanding element 24 include an element using multiple reflection and an element using a diffraction shape.

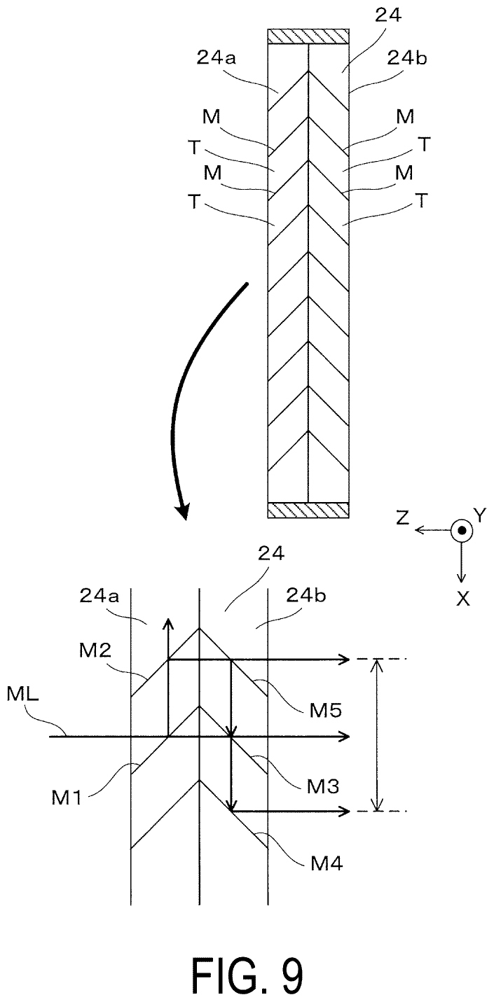

FIG. 9 is a view illustrating an example of the pupil expanding element 24 using multiple reflection. The pupil expanding element 24 illustrated in FIG. 9 is a parallel flat plate member obtained by bonding first and second optical members 24a and 24b to each other. Each of the optical members 24a and 24b includes a plurality of semi-transmitting reflection mirrors M and a plurality of transmissive members T. The semi-transmitting reflection mirror M is formed to be inclined with respect to incidence surfaces of the first and second optical members 24a and 24b. Each of the semi-transmitting reflection mirrors M provided to the first optical member 24a is provided to intersect with each of the semi-transmitting reflection mirrors M provided to the second optical member 24b.

In the first optical member 24a, a semi-transmitting reflection mirror M1 transmits part of the image light ML, which is incident on the first optical member 24a, in the −Z direction, and reflects the other part thereof in the −X direction. A semi-transmitting reflection mirror M2 is arranged on the −X side of the semi-transmitting reflection mirror M1. Some part of the image light ML reflected by the semi-transmitting reflection mirror M1 is reflected in the −Z direction, and the other part thereof is transmitted in the −X direction. In the second optical member 24b, a semi-transmitting reflection mirror M3 is arranged in the −Z direction with respect to the semi-transmitting reflection mirror M1 of the first optical member 24a. Some part of the image light ML transmitted through the semi-transmitting reflection mirror M1 is transmitted in the −Z direction, and the other part thereof is reflected in the +X direction. A semi-transmitting reflection mirror M4 is arranged on the +X side of the semi-transmitting reflection mirror M3. Some part of the image light ML reflected by the semi-transmitting reflection mirror M3 is reflected in the −Z direction, and the other part thereof is transmitted in the +X direction. A semi-transmitting reflection mirror M5 is arranged on the −X side of the semi-transmitting reflection mirror M3 and on the −Z side of the semi-transmitting reflection mirror M2. Some part of the image light ML reflected by the semi-transmitting reflection mirror M2 is transmitted in the −Z direction, and the other part thereof is reflected in the +X direction. As described, in the pupil expanding element 24, the image light ML is reflected for a plurality of times. With this, a beam diameter of the image light ML can be expanded in the X direction.

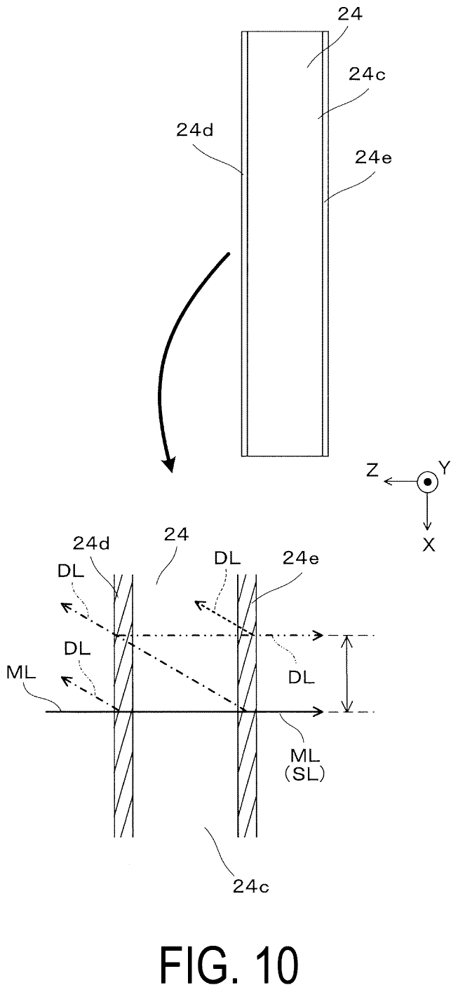

FIG. 10 is a view illustrating an example of the pupil expanding element 24 using a diffraction shape. The pupil expanding element 24 illustrated in FIG. 10 includes a base plate 24c having light transmittance, a first hologram element 24d provided to the base plate 24c on one side, and a second hologram element 24e provided to the base plate 24c on the other side. The first and second hologram elements 24d and 24e include reflection-type diffraction elements. The first and second hologram elements 24d and 24e may be other than volume holograms, and may be formed by nano-imprinting.

The first hologram element 24d transmits some part of the image light ML incident thereon, and the second hologram element 24e also transmits some part of the image light ML incident thereon. The second hologram element 24e diffracts the other part of the image light ML incident thereon toward the first hologram element 24d, and the first hologram element 24d diffracts diffraction light DL that is diffracted by the second hologram element 24e and is returned so that the diffraction light DL advances toward the second hologram element 24e again. The diffraction light DL is emitted in a state of being shifted in parallel to the same direction as straight light SL that directly passes through the first and second hologram elements 24d and 24e. As described above, in the pupil expanding element 24, the image light ML is diffracted for a plurality of times (specifically, 2n times). With this, a beam diameter of the image light ML can be expanded in the X direction.

Note that, although omitted in illustration, as the pupil expanding element 24 using a diffraction shape, a transmission-type diffraction element may be used instead of the reflection-type diffraction element illustrated in FIG. 10.

Further, although omitted in illustration, a liquid crystal lens may be provided in place of the pupil expanding element 24. Specially, the liquid crystal lens selectively acts as a lens for polarized light being any one of vertically polarized light and horizontally polarized light by changing a refractive index. Specifically, the liquid crystal lens selectively refracts the image light ML without refracting the external light OL, and collimates the image light ML to parallel light. When the liquid crystal lens is provided, the polarization directions of the external light OL and the image light ML are adjusted by providing a polarizing plate, a wavelength plate, and the like. The composite display member 20 is combined with the liquid crystal lens. With this, display on a large screen can be performed with a small-sized optical system. Here, display on a large screen indicates a case in which a virtual image of 70 inches or larger is formed at a distance of 2.5 m ahead, for example.

### Modification Examples and Others

Although the present disclosure has been described with reference to the above-described exemplary embodiments, the present disclosure is not limited to the above-described exemplary embodiments and can be implemented in various modes without departing from the spirit of the disclosure. For example, the following modifications are possible.

In the exemplary embodiment described above, arrangement and the sizes of the pixel display region PA and the light transmitting region A2 of the image display device 22 may be changed as appropriate so that a sufficient see-through region is present in one pixel.

In the exemplary embodiment described above, the outer shape of the micro optical element 23b of the optical array 23 is a rectangular shape, but may be a circular shape or an oval shape. The shape of the light shielding layer 21b of the light shielding member 21 preferably matches with the shape of the pixel display region PA of the image display device 22 so that incidence of the external light OL on the micro optical element 23b is prevented.

In the exemplary embodiment described above, the micro optical element 23b of the optical array 23 is not limited to a flat convex lens, and may be a diffraction element of a refractive index distribution type such as a hologram and liquid crystal. In a case of the diffraction element, the micro optical element is produced by exposure to light with a micro lens or a method using diffraction at the time of exposure to light with a pin hole having a small diameter. Further, the micro optical element 23b may be a geometric phase lens, a meta lens, or the like.

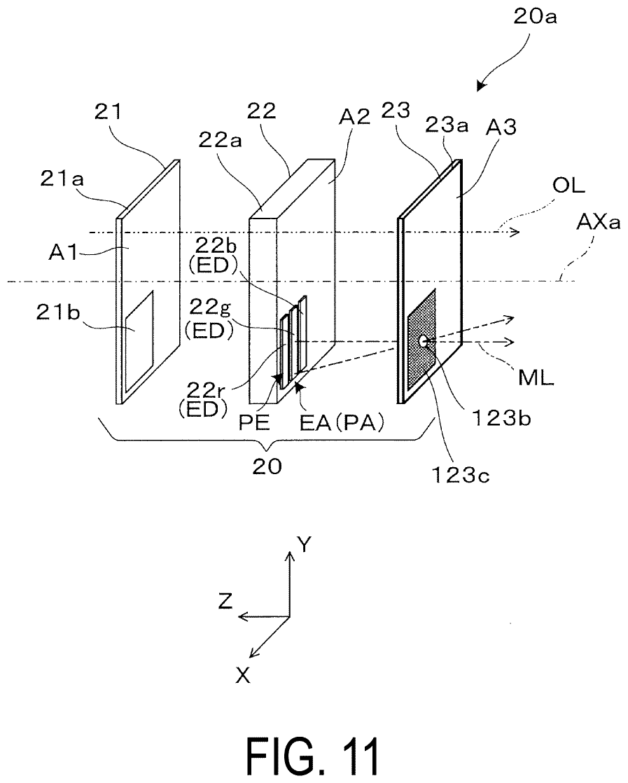

Further, as the micro optical element 23b, a pin hole may be used to adjust the depth of focus, in place of the micro lens Ma. For example, as illustrated in FIG. 11, a pin hole 123b through which the light passes is formed in a part of a light shielding region 123c provided to the optical array 23. The light shielding region 123c has a size and a shape corresponding to the light shielding layer 21b of the light shielding member 21 and the pixel display region PA of the image display device 22. A size of the pin hole 123b is as large as approximately one fifth to one tenth of the size of the pixel PE, for example. According to the angle of field of the pixel PE, the pin hole 123b is adjusted. For example, according to the distance from the optical axis AX, the position of the pin hole 123b is shifted.

In the exemplary embodiment described above, the image display device 22 and the light shielding member 21 may be integrated with each other. For example, on the surface of the flat plate 22a being a base plate of the image display device 22, which is on the external side, the light shielding layer 21b may be provided at a position corresponding to the pixel display region PA.

Although it has been assumed above that the HMD 200 is worn on the head and is used, the virtual image display devices 100A and 100B may also be used as a hand-held display that is not worn on the head and is to be looked into like binoculars. In other words, the head-mounted display also includes a hand-held display in the present disclosure.

According to a specific aspect, a virtual image display device includes an image display device including a pixel display region for displaying an image and a light transmitting region for causing external scenes to be visually recognizable, an optical array being arranged on a face side of the image display device, including a plurality of micro optical elements provided corresponding to respective pixels, and being configured to form an image with image light emitted from the image display device, and a light shielding member being arranged on an external side of the image display device and being configured to suppress incidence of external light on the pixel display region.

In the virtual image display device described above, the image display device includes the light transmitting region to achieve a see-through state. Thus, an additional relay optical system or the like is not required, and the device can be reduced in size. Further, the light shielding member suppresses incidence of the external light on the pixel display region. With this, incidence of the external light on the optical array via the pixel display region can be suppressed. With this, the external light is not subjected to an action of the optical element. Thus, the external light can be prevented from being visually recognized as a multiple image, and see-through performance can be improved. The light shielding member and the optical array are combined with the image display device, as described above. With this, the device can be reduced in size, and an angle of view can be increased.

In the virtual image display device according to the specific aspect, the optical array includes a micro lens as the micro optical element for causing the pixel or a sub pixel constituting the image display device to form an image individually. The micro lens is arranged in the vicinity of the image display device, and hence the virtual image display device can be reduced in thickness.

In the virtual image display device according to the specific aspect, the pixel display region is a light emitting region corresponding to the pixel or a sub pixel, and the micro optical element is arranged in a region corresponding to the light emitting region. With this, the image light that is emitted from the light emitting region to the face side can be used for formation of a virtual image while suppressing incidence of the external light on the micro optical element.

In the virtual image display device according to the specific aspect, the light shielding member includes the light shielding layer configured to suppress incidence of the external light, and the light shielding layer is arranged in a region corresponding to the pixel or a sub pixel of the pixel display region. The transmittance of the external light can be increased while the light shielding layer provided to each pixel prevents the external light from entering a path of the image light and being stray light.

In the virtual image display device according to the specific aspect, the micro optical element has a size corresponding to the pixel display region. With this, the light shielding layer of the light shielding member can be limited to a minimal necessary area, and hence the transmittance of the external light can be increased.

In the virtual image display device according to the specific aspect, the micro optical element has a shape corresponding to the pixel display region. With this, the light shielding layer of the light shielding member can be limited to a minimal necessary area, and hence the transmittance of the external light can be increased.

In the virtual image display device according to the specific aspect, the light shielding member includes a light shielding layer configured to suppress incidence of the external light, and the micro optical element has a size corresponding to the light shielding layer. With this, incidence of the external light on the micro optical element, which is blocked by the light shielding layer, can be prevented.

In the virtual image display device according to the specific aspect, the light shielding member includes a light shielding layer configured to suppress incidence of the external light, and the light shielding layer has a size corresponding to the pixel display region. With this, incidence of the external light on the pixel display region can further be suppressed.

In the virtual image display device according to the specific aspect, the light shielding member includes the light shielding layer configured to suppress incidence of the external light, and the light shielding layer is arranged in a region corresponding to the pixel or a sub pixel of the pixel display region.

In the virtual image display device according to the specific aspect, the light shielding member, the image display device, and the optical array are fixed. With this, the device can be relatively reduced in thickness.

According to a specific aspect, a head-mounted display apparatus includes a first device including the virtual image display device described above, a second device including the virtual image display device described above, and a support device configured to support the first device and the second device and be worn on a head.

What is claimed is:

1. A virtual image display device, comprising:
an image display device including a pixel display region for displaying an image and a light transmitting region for causing external scenes to be visually recognizable;
an optical array being arranged on a face side of the image display device, including a plurality of micro optical elements provided corresponding to respective pixels, and being configured to form an image with image light emitted from the image display device; and
a light shielding member being arranged on an external side of the image display device and being configured to suppress incidence of external light on the pixel display region.

2. The virtual image display device according to claim 1, wherein
the optical array includes a micro lens as the micro optical element for causing the pixel or a sub pixel constituting the image display device to form an image individually.

3. The virtual image display device according to claim 1, wherein
the pixel display region is a light emitting region corresponding to the pixel or a sub pixel, and
the micro optical element is arranged in a region corresponding to the light emitting region.

4. The virtual image display device according to claim 1, wherein
the light shielding member includes a light shielding layer configured to suppress incidence of the external light, and
the light shielding layer is arranged in a region corresponding to the pixel or a sub pixel of the pixel display region.

5. The virtual image display device according to claim 1, wherein
the micro optical element has a size corresponding to the pixel display region.

6. The virtual image display device according to claim 1, wherein
the micro optical element has a shape corresponding to the pixel display region.

7. The virtual image display device according to claim 1, wherein
the light shielding member includes a light shielding layer configured to suppress incidence of the external light, and
the micro optical element has a size corresponding to the light shielding layer.

8. The virtual image display device according to claim 1, wherein
the light shielding member includes a light shielding layer configured to suppress incidence of the external light, and
the light shielding layer has a size corresponding to the pixel display region.

9. The virtual image display device according to claim 1, wherein
the light shielding member includes a light shielding layer configured to suppress incidence of the external light, and
the light shielding layer is arranged in a region corresponding to the pixel or a sub pixel of the pixel display region.

10. The virtual image display device according to claim 1, wherein
the light shielding member, the image display device, and the optical array are fixed.

11. A head-mounted display apparatus, comprising:
a first device including the virtual image display device according to claim 1;
a second device including the virtual image display device according to claim 1; and
a support device including a temple configured to support the first device and the second device so that the first device and the second device are wearable on a head.
